(19) United States
(12) Patent Application Publication
(10) Pub. No.: US 2019/0084843 A1
(43) Pub. Date: Mar. 21, 2019

(54) SYSTEM AND METHOD FOR WATER TREATMENT

(71) Applicant: University of Idaho, Moscow, ID (US)

(72) Inventors: Gregory Möller, Moscow, ID (US); Daniel Strawn, Moscow, ID (US); Martin Baker, Moscow, ID (US); Gene Staggs, Moscow, ID (US)

(73) Assignee: University of Idaho, Moscow, ID (US)

(21) Appl. No.: 16/193,982

(22) Filed: Nov. 16, 2018

Related U.S. Application Data
(63) Continuation of application No. PCT/US2017/033628, filed on May 19, 2017.
(60) Provisional application No. 62/341,906, filed on May 26, 2016.

(51) Int. Cl. C02F 1/28; C02F 1/78; B01D 24/28; B01D 24/36

(52) U.S. Cl. CPC C02F 1/283; C02F 1/285; C08L 5/08; B01D 24/28; B01D 24/36; C02F 1/78

(57) ABSTRACT

Disclosed herein are embodiments of a system for treating water. The system comprises one or more inlets for introducing biochar and polyamine to the water, such as a biochar inlet and a polyamine inlet, or a biochar/polyamine mixture inlet. The system may optionally also include a metal salt inlet, ozone inlet, an additional organic carbon compound inlet, or any combination thereof. The biochar and polyamine may optionally be premixed prior to addition to the water. The system also comprises a filtration device, such as a reactive filtration device. The system produces a treated water stream and a reject stream, which may be further separated into a recycled water stream and a solid product. The solid product may be suitable as a soil amendment for application to agricultural land, or for recycling. A method for using the system to treat water, particularly nitrate-contaminated water, also is disclosed.

### CROSS REFERENCE TO RELATED APPLICATION

This application is a continuation of International Application No. PCT/US2017/033628, filed on May 19, 2017, which claims the benefit of the earlier filing date of U.S. Provisional Application No. 62/341,906, filed May 26, 2016, both of which are incorporated herein by reference in their entireties.

### ACKNOWLEDGMENT OF GOVERNMENT SUPPORT

This invention was made with government support under IDA01457 awarded by the United States Department of Agriculture Regional Research Hatch Project. The government has certain rights in the invention.

### FIELD

Certain disclosed embodiments concern a system for water treatment comprising biochar and polyamine addition and a method for using the system to treat water.

### BACKGROUND

The impact of nutrient pollution from phosphorus and nitrogen on the nation's waters is significant. The estimated annual cost of freshwater nutrient pollution in the United States is greater than $2.2 billion. The U.S. Environmental Protection Agency (EPA) found that about 40% of stream miles in the United States had elevated phosphorus levels and 27% had elevated nitrogen levels. The National Centers for Coastal Ocean Science (NCCOS) has estimated that nutrient pollution has had a moderate-to-high impact in 65% of the coastal areas observed.

Nitrogen is required for life. Nitrogen is an essential element in amino acids, proteins and DNA. Nitrogen gas (N₂) makes up about 78% of the Earth's atmosphere, but this form of nitrogen is generally inert. Other, reactive species of nitrogen include ammonia (NH₃), nitrate (NO₃⁻), nitrite (NO₂⁻), or nitrous oxide (N₂O). Reactive nitrogen can impact both the environment and human health. One natural process that creates reactive nitrogen is nitrogen fixation by microbes. The human creation of reactive nitrogen by food and energy production has both beneficial and detrimental effects on people and on the environment. One beneficial impact of the agricultural use of reactive nitrogen comes from the food produced by nitrogen fertilizer and human-enhanced biological nitrogen fixation. Detrimental impacts can result because a large fraction of the nitrogen used in food, biofuel, biofuel production, and non-biofuel (i.e. non-agricultural) energy production is lost to the environment.

Nitrate (NO₃⁻) is often found in agricultural run-offs and municipal wastewater. Nitrate contamination in surface water and groundwater has become a global concern because it poses a threat to drinking water supplies and accelerates eutrophication. For example, the discharge of wastewater with excess nitrate in the Mississippi River is one of the main causes of hypoxia (i.e.

oxygen deficiency) and the formation of the “Dead Zone” in the Northern Gulf of Mexico. Nitrates can reduce the ability of red blood cells to carry oxygen. Consumed nitrates may be reduced to nitrites in the gastrointestinal tract. Upon absorption into the bloodstream, nitrites react with hemoglobin to produce methemoglobin, which impairs oxygen transport. High nitrate concentration in drinking water sources can be a public health risk, and may result in an increased risk of disease, such as birth defects, spontaneous abortion, increased infant mortality, diarrhea, abdominal pain, vomiting, diabetes, hypertension, respiratory tract infections, changes in the immune system, or methemoglobinemia. The World Health Organization (WHO) has established a limit for nitrate in drinking water of 10 mg NO₃⁻-N/L (nitrate-nitrogen per liter).

Although nitrate can be quantitatively removed by several technologies including ion exchange resins and reverse or forward osmosis, such processes are expensive and thus usually are applied only to drinking water resources. In wastewater discharge nitrogen (N) treatment, including, but not limited to, removal of nitrate, nitrite, ammonium ions, ammonia, and nitrogenous organic molecules, typical approaches use microbial denitrification stimulated by addition of a carbon source such as methanol, or more recently anaerobic ammonium oxidation (as used by the Anammox® technology), which uses a specific microbial system that converts ammonium and nitrite to N₂.

Biological treatment for nitrogen removal is typically less expensive than as ion exchange or osmosis. However, the requirement of large bioreactors, sufficient incubation and reaction time and associated pumps and energy demands, can make biological treatment of nitrogen-containing wastewaters economically challenging. Also, many nitrogen microbial treatment processes reduce or remove the potential to use the nitrate as a nutrient in a fertilizer for agriculture because the processes typically convert the nitrate to nitrogen gas (N₂), which is then released into the atmosphere. Furthermore, biological nitrogen removal processes often do not treat wastewaters sufficiently to obtain the very low total nitrogen levels required for some nutrient-impacted aquatic ecosystems.

### SUMMARY

In view of the above, there is a need for a process that can provide an economical approach to recycling and reusing nitrogen and/or phosphorus for increased sustainability. There is also a need for a process that can remove other contaminants from wastewater, including trace organic compounds, hormones, antibiotics, and pathogens. Disclosed herein are embodiments of a system and method for water treatment that address these needs. In some embodiments, the system comprises a fluid flow pathway, comprising a wastewater inlet for introducing a wastewater stream to the pathway, one or more inlets for introducing biochar and polyamine, or a biochar/polyamine mixture, to the pathway, and a reactor. The system further comprises a filter downstream of the reactor and the one or more inlets, the filter fluidly coupled to the fluid flow pathway; a treated water outlet fluidly coupled to the filter; and a reject stream outlet fluidly coupled to the filter. In some embodiments, the one or more inlets are upstream of the reactor. Biochar and polyamine may be separately introduced to the fluid flow pathway through a biochar inlet and a polyamine inlet respectively. Alternatively, the biochar and polyamine may be premixed to form a mixture that may be a composition comprising biochar and polyamine, the mixture being added to the fluid flow pathway through an inlet. The biochar inlet and/or the polyamine inlet may be upstream of the reactor. The fluid flow pathway may also comprise a metal salt inlet for introducing a metal salt to the fluid flow pathway. The metal salt inlet may be upstream of the reactor, or downstream of the reactor. The fluid flow pathway may further comprise an oxidant inlet, such as an ozone inlet, an additional organic carbon compound inlet or a combination thereof, each of which independently may be upstream or downstream of the reactor.

In certain embodiments, the biochar is a composition comprising a pyrolyzed biomass biochar, a hydrothermal carbonization-produced biomass biochar, or a combination thereof. The biomass may be selected from agricultural crop waste, forestry waste, algae, animal or human waste, industrial waste, municipal waste, anaerobic digester waste, plant materials grown for the production of biomass, or a combination thereof. In some embodiments, the biochar is a powdered solid, granules, pulverized solid, or fluid slurry, and in certain examples the biochar further comprises a metal salt solution.

A polyamine is a compound comprising two or more primary, secondary, tertiary or quaternary amines, or combinations thereof. One or more of the amines may be protonated. The polyamine may comprise a single polyamine compound or it may comprise two or more polyamine compounds. In some embodiments, the polyamine is a polymer comprising two or more amines. The polymer may be a linear, cyclic or branched polymer. In some embodiments, the polyamine is chitosan. In other embodiments, the polyamine is a dendrimer, such as a 1^{st}, 2^{nd}, 3^{rd}, 4^{th}, 5^{th}, 6^{th} or more generation dendrimer. In certain embodiments, the polyamine is a polyethyleneimine (PEI) polymer and may be a branched and/or dendritic PEI. The PEI may comprise repeating subunits that may include quaternary ammonium sites, as well as tertiary, secondary and primary amine sites depending on specific formulations. The PEI polymer typically has a molecular weight of from 600 to 60,000 or more.

Polyamines, such as PEI and/or chitosan, may be useful in water treatment to help coagulate and separate particles suspended in solution. The biochar surface can be modified by mixing the biochar with a polyamine. A polyamine, such as PEI and/or chitosan, can attach to the biochar surface through any suitable attachment process, such as covalent bonding, absorption, adsorption, electrostatic attraction or a combination thereof. In some embodiments, biochar is pretreated with an activating agent, such as acid, alkali, or an oxidizing agent. In some embodiments, the oxidizing agent is ozone. Additionally, or alternatively, the biochar may be treated with a crosslinking agent and/or transesterification agent before the polyamine is added. In some embodiments, the transesterification agent is an alcohol-alkali mixture, such as a methanol-NaOH mixture. In other embodiments, the crosslinking agent is glutaraldehyde. In some embodiments, biochar with adequate native surface binding properties for good adsorptive or ion exchange adhesion and modification is mixed with the polyamine. In certain embodiments, a low-to-moderate molecular weight polyamine, such as PEI, was used, such as a polyamine having a molecular weight of from 600 to 6000. In other embodiments, chitosan having a molecular weight of from 3,800 to 20,000 was used. In some embodiments, the polyamine polymer chain length and therefore molecular weight may be selected such that it will modify the biochar surface but not “fill” the desirable biochar surface pores.

Suitable metal salts include a metal salt concentrate, metal salt solution, metal salt powder, metal salt granule, metal salt slurry, metal salt suspension or combination thereof. The metal salt includes a suitable metal, typically iron, aluminum, calcium, magnesium, manganese, zinc, copper or a combination thereof, and in some examples, the metal salt comprises ferrous or ferric cations, ferrate anions, or a combination thereof. In particular embodiments, the metal salt comprises ferric halide, such as chloride.

The reactor may agitate a fluid in the fluid flow pathway, generate or increase turbulence within the fluid, or a combination thereof. In certain embodiments, the reactor is a plug flow reactor, and may be a serpentine plug flow pipe reactor.

The filter may be a moving bed filter, moving bed reactive filter, continuously moving bed filter, a continuously moving bed reactive filter, a cycled backwash, fluidized bed, agitated bed, horizontal flow bed of the filter substrate, membrane filter, disk filter, cloth filter or combinations thereof. The filter may comprise a filtration substrate selected from natural minerals, synthetic minerals, polymeric beads, plastic beads, carbonaceous substrates, or combinations thereof. In some embodiments, the filtration substrate is sand, garnet sand, anthracite coal, or a combination thereof, and in certain embodiments, the filter is a continuously moving bed reactive sand filter.

The system may further comprise a solids separator fluidly coupled to the reject stream outlet. In some examples, the solids separator further comprises a recycled water outlet and a solids outlet, and the solids outlet may output a solid suitable for recycling or application to agricultural land. The solids separator may comprise a settling basin, mesh filter, membrane filter, cloth filter, sand filter, rotating mat filter, chemical coagulator, polymer addition, centrifugal force separator, sieve, magnetic separator, plate clarifier, basin clarifier, coalescence separator or a combination thereof.

The system may further comprise an energy generator, which generates energy by biomass pyrolysis. The biomass pyrolysis may produce biochar suitable for use in the system. The energy generator may also generate heat, steam, syngas, or a combination thereof.

A method for treating water is also disclosed. In some embodiments, the method comprises adding biochar, polyamine, or a biochar/polyamine mixture to a wastewater stream that comprises at least one contaminant. The biochar, polyamine and/or polyamine-modified biochar and at least one contaminant are separated from the wastewater stream to produce a treated water stream and a reject stream. The contaminant may comprise a nitrogen compound, such as a nitrate or ammonia. The wastewater stream may comprise a first amount of the nitrate contaminant and the treated water stream comprise a second amount of the nitrate contaminant, less than the first amount. In some embodiments, the second amount is 90% or less of the first amount, such as 85% or less, 75% or less, 70% or less, 50% or less, 25% or less, 10% or less, 5% or less, or 1% or less of the first amount. In certain embodiments, the second amount is substantially zero. The biochar/polyamine mixture may be a physical mixture of biochar and polyamine, a composition comprising polyamine and biochar, or a combination thereof. A composition comprising polyamine and biochar may comprise polyamine attached to the biochar, particularly the surface of the biochar. The polyamine may be attached through adsorption, absorption, covalent bonding, electrostatic attraction, or a combination thereof. The method may further comprise adding a metal salt, ozone, an additional organic carbon compound, or any combination thereof, to the wastewater stream. In certain embodiments, the method comprises adding biochar and polyamine separately to the waste water pathway.

Separating the biochar, polyamine and/or polyamine-modified biochar and at least one contaminant from the wastewater stream may comprise filtering the wastewater stream comprising the biochar, polyamine and/or polyamine-modified biochar and at least one contaminant using a filter. The filter can be any filter suitable for separating solids from solutions including, but not limited to, gravity settling, clarifiers, centrifugal filters, mat filters, cross-flow filters, membrane filters, press filters, fine pore filters, disk filters, polymeric media filters, and electrostatic filters. Biochar is added to the wastewater stream in an effective amount, such as from 1 milligram to 2 grams per gallon of wastewater, or from 5 milligrams to 1 gram per gallon of wastewater. Metal salt is added to the wastewater in an effective amount, such as from greater than zero to 100 milligrams per liter of wastewater. The polyamine may be added to the wastewater in an effective amount, such as from greater than zero to 1000 milligrams per gallon of wastewater. In certain embodiments, the polyamine is PEI, and the PEI is added to the wastewater stream in an amount of from 0.1 milligrams to 500 milligrams or more per gallon of wastewater. In other embodiments, the polyamine/biochar mixture is added to the wastewater in an amount of from 1 milligram to 10 grams or more per liter, such as from 100 milligrams to 5 grams, from 500 milligrams to 2.5 grams, and in certain embodiments, about 1 gram of the polyamine/biochar mixture per liter of wastewater is used.

In some embodiments, the wastewater stream is mixed with the biochar, polyamine and/or metal salt in a reactor. The reactor may agitate the wastewater stream, generate or increase turbulence within the wastewater stream, or a combination thereof, and in some examples, the reactor is a plug flow reactor, and in certain examples, the reactor is a serpentine plug flow pipe reactor.

The method may further comprise separating the reject stream into a recycled water stream and a solid by-product, which may be suitable for recycling or application to agricultural, silvicultural, residential, commercial, or municipal land or horticultural soil containers. The method may further comprise pelletizing the solid by-product.

In some examples, the method further comprises pyrolyzing a biomass to generate biochar, and the pyrolysis may also generate heat, steam, syngas or a combination thereof.

In certain embodiments, the method further comprises testing the wastewater stream to determine an amount of the at least one contaminant present in the wastewater stream, and adjusting a rate of addition and/or an amount of addition of the biochar, polyamine, polyamine/biochar mixture and/or metal salt commensurate with the changes in the amount of at least one contaminant present in the wastewater stream.

The foregoing and other objects, features, and advantages of the invention will become more apparent from the following detailed description, which proceeds with reference to the accompanying figures.

Other embodiments of the invention are discussed throughout this application. Any embodiment discussed with respect to one aspect of the invention applies to other aspects of the invention as well and vice versa. Each embodiment described herein is understood to be an embodiment of the invention that is applicable to all aspects of the invention. Any embodiment discussed herein can be implemented with respect to any method or composition of the invention, and vice versa. Furthermore, compositions and kits of the invention can be used to achieve methods of the invention.

The foregoing and other objects, features, and advantages of the invention will become more apparent from the following detailed description, which proceeds with reference to the accompanying figures.

### BRIEF DESCRIPTION OF THE DRAWINGS

FIG. 1 is a flow chart illustrating an exemplary embodiment of a process for producing biochar.

FIG. 2 is a branched PEI fragment.

FIG. 3 is an exemplary polyethyleneimine (PEI) dendrimer.

FIG. 4 is a flow chart illustrating an exemplary embodiment of the process disclosed herein.

FIG. 5 is a flow chart illustrating another exemplary embodiment of the process disclosed herein.

FIG. 6 is a flow chart illustrating an exemplary embodiment of the disclosed process that comprises the process illustrated in FIG. 4 combined with onsite biochar production.

FIG. 7 is a flow chart illustrating another exemplary embodiment of the disclosed process that comprises the process illustrated in FIG. 5 combined with onsite biochar production.

FIG. 8 is a cross-sectional representation of a moving bed reactive sand filter.

FIG. 9 is a flow chart illustrating separation of the reject stream into recycled water and solids.

### DETAILED DESCRIPTION

### I. Definitions

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. All references, including patents and patent applications cited herein, are incorporated by reference.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

Unless explained otherwise, all technical and scientific terms used herein have the same meaning as commonly understood to a person of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting.

The term “aliphatic” refers to a substantially hydrocarbon-based group or moiety, including alkyl, alkenyl and alkynyl, and further includes straight, branched and cyclic versions thereof. “Cycloaliphatic” groups or moieties include cycloalkyl, cycloalkenyl, or cycloalkynyl groups or moieties. The term aliphatic also includes all stereo and geometric isomers. Unless expressly stated otherwise, an aliphatic group generally contains from one up to at least twenty five carbon atoms; for example, from one to twenty, from one to fifteen, from one to ten, from one to six, or from one to four carbon atoms. A person of ordinary skill in the art will appreciate that an alkenyl or alkynyl group or moiety must have a minimum of two carbon atoms, such as from two to twenty five carbon atoms, and a cycloaliphatic group or moiety must have a minimum of three carbon atoms, such as from three to twenty five carbon atoms. An aliphatic group or moiety may be optionally substituted, unless expressly described as substituted or unsubstituted.

The term “alkyl,” refers to a saturated aliphatic hydrocarbyl group having from one to twenty five carbon atoms, typically from one to ten carbon atoms, such as from one to six carbon atoms (C₁-C₆alkyl) or one to four carbon atoms (C₁-C₄alkyl). An alkyl moiety may be substituted or unsubstituted. Non-limiting examples of linear and branched hydrocarbyl groups include —CH₃(Me), —CH₂CH₃ (Et), —CH₂CH₂CH₃ (n-Pr), —CH(CH₃)₂ (iso-Pr), —CH₂CH₂CH₂CH₃ (n-Bu), —CH(CH₃)CH₂CH₃ (sec-butyl), —CH₂CH(CH₃)₂ (iso-butyl), —C(CH₃)₃ (tert-butyl), and —CH₂C(CH₃)₃ (neo-pentyl). Exemplary substituted alkyl groups include, —CF₃, —CH₂Cl, —CH₂Br, —CH₂OH, —CH₂NH₂, —CH₂CH₂Cl, —CH₂CH₂OH,

The term “amine” or “amino “refers to a group or moiety having a structure —NR′R″, where R′ and R″ are independently hydrogen or an optionally substituted aliphatic, heteroaliphatic or aryl group. The term “amine” includes primary, secondary, tertiary and quaternary amines.

The term “aryl” means a polyunsaturated, aromatic, hydrocarbon group or moiety. Aryl groups or moieties can be monocyclic or polycyclic (e.g., at least 2 rings that are fused together where at least one of the fused rings is aryl). The term “heteroaryl” refers to an aryl group that contains at least one up to at least four heteroatoms, wherein the heteroatoms typically independently are selected from N, O, or S. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. An aryl group can be optionally substituted, unless expressly described as substituted or unsubstituted.

The terms “halo” or “halogen” refer to F, Cl, Br or I.

The term “heteroaliphatic,” by itself or in combination with another term, refers to an aliphatic group or moiety having at least one carbon atom and at least one heteroatom selected from O, N, S, P, or Si. In certain embodiments, the heteroatoms are 0 or N. The heteroatom(s) may be placed at any position in the heteroaliphatic group, including at the position at which the aliphatic group is attached to the remainder of the molecule, such as in methoxy or ethoxy moieties. Up to two heteroatoms may be consecutive. A heteroaliphatic group or moiety may be optionally substituted, unless expressly described as substituted or unsubstituted. Heterocycloaliphatic and cycloheteroaliphatic refer to cyclic versions of a heteroaliphatic group or moiety. The following groups are all non-limiting examples of heteroaliphatic groups: —CH₂OCH₃, —CH₂OCH₂CF₃, —CH₂OC(O)CH₃, —CH₂NHCH₃, —CH₂N(CH₃)₂, CH₂CH₂OC(O)CH₃, —CH₂CH₂NHCO₂C(CH₃)₃ and —CH₂Si(CH₃)₃.

Various groups are described herein as substituted or unsubstituted (i.e., optionally substituted). Optionally substituted groups may include one or more substituents, which generally means an atom other than hydrogen or a functional group that replaces hydrogen. Substituents include, but are not limited to substituents independently selected from: halogen, such as F, Cl, Br or I; NO₂; CN; haloalkyl, typically CF₃; OH; amino; SH; —CHO; —CO₂H; oxo (═O); —C(═O)amino; NRC(═O)R; aliphatic, typically alkyl; heteroaliphatic; —OR; —SR; —S(═O)R; —SO₂R; aryl; or heteroaryl; where each R independently is aliphatic, typically alkyl, aryl, or heteroaliphatic. In certain aspects the optional substituents may themselves be further substituted with one or more unsubstituted substituents selected from the above list. Exemplary optional substituents include, but are not limited to: —OH, oxo (═O), —Cl, —F, Br, C₁₋₄alkyl, phenyl, benzyl, —NH₂, —NH(C₁₋₄alkyl), —N(C₁₋₄alkyl)₂, —NO₂, —S(C₁₋₄alkyl), —SO₂(C₁₋₄alkyl), —CO₂(C₁₋₄alkyl), and —O(C₁₋₄alkyl).

### II. Overview

Disclosed herein are embodiments of a water treatment apparatus comprising one or more inlets for introducing biochar and a polyamine, or a combination thereof, that can efficiently remove, recover and recycle contaminant nutrients from a wastewater stream. U.S. Pat. Nos. 7,399,416 and 7,713,423, both incorporated herein by reference, describe a reactive filtration process and system where a metal salt reagent is added to a water stream upstream from a bed of moving sand. The sand becomes coated with adsorptive iron oxyhydroxides, which act to remove contaminants from water. The motion of the sand acts to remove the coating, which can be washed or back-washed from the sand bed, thus removing the contaminants from the fluid. U.S. Pat. Nos. 7,445,721 and 7,744,764, both incorporated herein by reference, augment this reactive filtration by adding ozone. This allows oxidative destruction and removal of chemical contaminants via direct ozone chemical reaction, indirect oxidative byproduct chemical reaction, and/or metal oxide catalytic reactions. U.S. Pat. No. 7,713,426, incorporated herein by reference, modifies this reactive filtration process to further expose the treated water to ultraviolet light. U.S. Pat. No. 8,071,055, incorporated herein by reference, places a reactive filtration process after membrane filtration, to treat water contaminants that are not efficiently removed by membrane filtration.

In all of these approaches, the removal of contaminants in a process reject stream, typically in a fluid stream that is a small fraction of the initial treatment fluid stream, allows physical separation of contaminants from the treated fluid stream. U.S. Pat. No. 8,080,163, incorporated herein by reference, discloses recycling the process reject stream upstream of the reactive filtration process effective to lower an average contaminant concentration of effluent water from the moving media filter. Overall reactive filtration has demonstrated highly efficient removal of nutrient phosphorus in wastewater streams in municipal and industrial wastewater applications. While cost efficient, and efficient in removing many contaminants from the fluid stream, reactive filtration using iron salt reagents alone, or in combination with an oxidizer, produces a rejection byproduct of concentrated iron oxides. This has some utility in recovering and reusing phosphorus, a key agriculture nutrient. However, repeated application of highly concentrated iron oxides to some soils may be harmful to some agronomic outcomes.

In addition, reactive filtration using metal salts has some demonstrated ability to remove trace organic chemicals by particulate removal, adsorptive interaction with the hydrous ferric oxides formed in the process, and by co-removal of dissolved and suspended organic material in the fluid stream. However, treated waters may include non-polar, organic chemical contaminants of high bioactivity and toxic concern. Examples of such materials include hormonal agents, pharmaceuticals, and their metabolites. These types of compounds may not be sufficiently removed to the very low levels that mitigate risk to public health and environmental quality using reactive filtration with metal salts.

Charcoals, activated charcoals, coal and carbonaceous composite substrates are commonly used in treating water or wastewater, as well as gaseous or vapor contaminants to remove trace organic chemicals, hazardous metals, and other toxic chemicals. It has been shown that cationic iron or other metal salts, such as aluminum salts, can chemically bind to the surface of charcoals, activated charcoals, coal and carbonaceous composite substrates. Both ferrous and ferric iron readily adsorb to the surface of charcoals, activated charcoals, coal and carbonaceous composite substrates to varying degrees. These metal-salt-amended and modified charcoals, activated charcoals, coal and carbonaceous composite substrates, are capable of additional and often advantageous reactive chemistries that improve removing some contaminants from fluids. U.S. Pat. No. 6,770,205, incorporated herein by reference, teaches treating pollutants using iron-impregnated, carbon-coated, silica sand. This approach requires high temperature processing to create a one-time use reactive substrate with significant manufacturing and processing complexity, and thus cost.

PCT patent application No. PCT/US2013/026975 describes a synthetic method for making modified biomass using a precursor metal solution and drying, growing plant materials with metal solution irrigation, or using the solid biomass residuals from anaerobic digestion. The modified biomass material is subjected to high temperature pyrolysis to form a biochar-metal composite. Iron-impregnated activated carbon has been used to adsorb heavy metals and iron oxide-impregnated activated carbon can remove arsenic. Additionally, methods have been described for preparing iron activated carbon composites to remove arsenic from water.

In all of these cases, the iron-amended charcoals or carbon composites require significant manufacturing steps and processing with other chemicals, producing a generic reactive substrate that may not have optimum performance for the contaminant mix in a particular wastewater. In addition, the utility in fluid filtering is limited by the finite adsorptive capacity of the metal-salt-amended and modified charcoals, activated charcoals, coal and carbonaceous composite substrates.

Metal-modified, bi-functional substrates for pollutant treatment have a significant development history as well in alternate solid substrates: U.S. Pat. Nos. 8,541,331 and 8,512,659 teach a method of synthesizing and using iron-containing aluminosilicate zeolites; U.S. Pat. No. 7,884,043 teaches manufacturing and using a zeolite modified with iron and aluminum for removing heavy metals from water; U.S. Pat. No. 7,658,853 describes a process for treating contaminated water by means of a bifunctional system including iron metal and zeolites; and U.S. Pat. No. 6,379,555 teaches a wastewater treatment process using activated carbon and magnesium hydroxide.

Although the use of charcoals, activated charcoals, coal and carbonaceous substrates is well demonstrated in numerous applications including water treatment, the use of biochar has recently been demonstrated to have the potential for biomass byproduct recycling, especially in agricultural, industrial and forest products' carbonaceous waste streams. Biochar typically results from the controlled pyrolysis of biomass, although it can also be manufactured using hydrothermal, high pressure and high temperature water processing of biomass. The primary biochar applications are: As an energy generation byproduct resource; for use in carbon sequestration; as a soil amendment; and as a carbonaceous substrate for water treatment. Depending on the biomass source and production method of the biochar, polar functional groups on the native charred material, such as hydroxyl and carboxylic acid groups, present active adsorption sites. These active adsorption sites can adsorb metal cations, such as ferrous and ferric iron, in the general range of tens to one hundred milligrams of total iron per gram of carbonaceous substrate, and also adsorb phosphate, ammonium, and nitrate. An aluminum oxyhydroxide modified biochar nanocomposite removed phosphate and other contaminants from water. And magnetic iron oxide biochar preparations can adsorb contaminants and further allow magnetic separation. Iron metal filings and biochar has been demonstrated for contaminant removal. PCT patent application No. PCT/US2013/026975 describe a synthetic method of pretreating biomass with a precursor metal solution, growing plant materials with metal solution irrigation, or using the solid biomass residuals from anaerobic digestion, then subjecting the biomass material to high temperature pyrolysis to form a biochar-metal composite. Additionally, a method of engineering biochar with magnesium to reclaim phosphate from water as a fertilizer has been described, and also a method for enhancing the nitrate sorption capacity of strong acid chemically activated biochars. And the catalytic potential of biochar with ozonation or hydrogen peroxide addition to treat recalcitrant fluid contaminants has been described.

Runoff from agricultural land that has been treated with fertilizer can result in nutrient impacted water, such as when phosphorus and/or nitrogen compounds are washed into streams, rivers, ponds and lakes. Both phosphorus and nitrogen, often in the form of nitrate, from fertilizers can initiate undesirable aquatic ecosystem and water quality outcomes, sometimes resulting from accelerated algae growth and eutrophication. Biochar as a soil amendment has been shown to reduce phosphorus and nitrogen leaching while maintaining plant availability. Thus, adsorption of phosphorus and nitrogen compounds onto biochar can inhibit or substantially prevent these compounds being washed into the watercourses, when the mixture is used as a fertilizer. For example, ammonia adsorbs onto biochar, and the composition retains its stability in a soil matrix as a fertilizer, thus preventing runoff of nitrogenous compounds into the watershed. In the aqueous phase, this adsorption and bioavailability may result from formation of ammonium ions.

In an era of human-induced climactic change, the Emissions Gap Report 2013, published by the United Nations Environment Program, states that “regarding biomass, bioenergy production combined with carbon capture and storage (BioCCS) technology is a negative-emission solution that could offer a powerful means to reduce GHG emissions.” Furthermore, the Report states that “the use of BioCCS depends on the technical and social feasibility of large-scale CCS and the technical and social feasibility of sustainable large-scale bioenergy production.” Thus, there is a need to design and develop new biomass energy generation systems that co-produce clean water and enhance sustainable agriculture to advance technical and social feasibility of BioCCS.

While the promise of biochar and amended or engineered biochar for treating contaminants, nutrient control and nutrient recycling is significant, its use has been primarily limited to direct field application, or to water treatment columns, which are known for using charcoals, activated charcoals, coal and carbonaceous substrates. The major shortcomings that affect application of biochar for water treatment include: The engineered solutions for high flow fluids at industrial or municipal scale and distributed water treatment systems; structural integrity of the charred material; variability of the substrate properties arising from the variety of biomass sources; and in process control for reliable removal of contaminants and recyclable nutrients at high efficiency and low cost. Significant process improvements are needed to realize the promise of biochar, charcoals, activated charcoals, coal and carbonaceous substrates, modified or in their native state, to enhance water treatment and nutrient reuse for future sustainability. The disclosed embodiments address this need.

U.S. patent application Ser. No. 14/549,342, incorporated herein by reference, describes a reactive filtration process and system whereby biochar is added to a water stream prior to a moving bed reactive sand filter. Metals salts and ozone can optionally be added to water being treated. Crushing and grinding of biochar within the moving sand bed increases reactive surface area per unit mass, to further remove contaminants from the wastewater in the process. The added material can then also act as a dynamic filter aid by decreasing the net pore size of the sand filter bed as the biochar moves through the sand bed, thus retaining smaller contaminant particles and increasing overall filtration efficiency.

Nitrate capture has been demonstrated by an ammonium/biochar composition although often only with very high carbon concentrations over a longer time such as 10 grams of activated charcoal per liter for about one to several hours of contact time. A recent comprehensive review of the challenges of nitrate binding for water treatment and other applications suggests that it is difficult to effectively bind the weakly basic nitrate anion with a synthetic receptor, especially in polar solvents such as water.

### III. Description of the System

The disclosed embodiments concern a water treatment system and process. Certain disclosed embodiments integrate bioenergy production with carbon capture and storage technology. Such embodiments may comprise adding a particulate carbonaceous substrate with less material hardness than sand, adding a polyamine, and optionally adding a metal salt solution and/or ozone to the flowing fluid. This allows mixing and reaction time before filtration in a moving bed reactive filter that further allows for cleaned water and the separation of potentially useful solids.

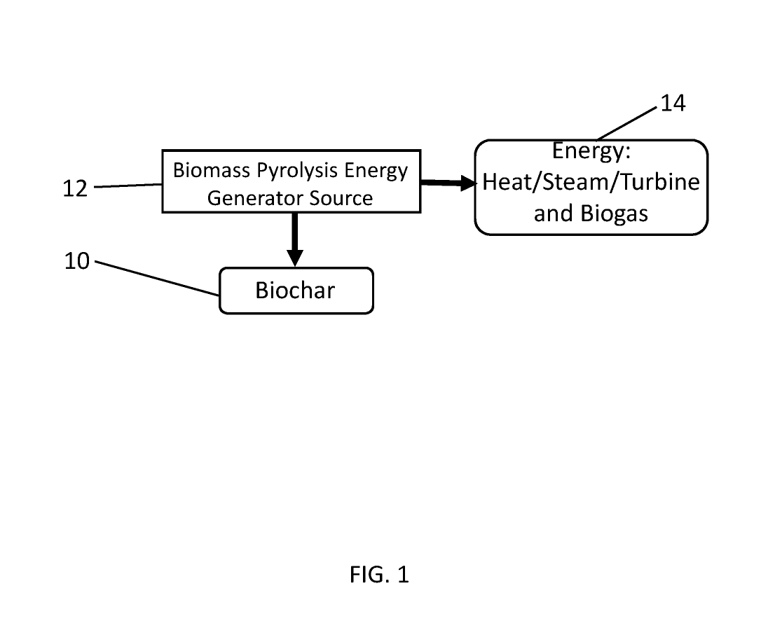

Biochar: Biochar 10 is typically produced by biomass pyrolysis or hydrothermal processing (FIG. 1). Biomass pyrolysis energy generator source 12 may provide an onsite or offsite energy generation resource through any of several energy conversion technologies 14 including, but not limited to, heat generation, steam generation, and syngas (synthesis gas) production. The biomass pyrolysis energy generator source 12 produces a biochar byproduct 10 having physical properties characterized by the high temperature controlled oxygen pyrolysis conditions in that source. The biomass pyrolysis energy generator source 12 can use an array of biomass materials including, solely by way of example, agricultural crop waste, forestry waste, algae, animal or human waste, industrial waste, anaerobic digester waste, or municipal waste or any combination of these. Plant materials grown for the purpose of biomass production, for example switchgrass straw, Panicum virgatum, are also a source of the biochar byproduct. Biochar product 10 can be produced in any of a number of physical forms, such as granular, pulverized, or powdered. Such biochar 10 can be used as directly produced by the biomass pyrolysis energy generator source 12 or after treatment or activation by chemical, physical, thermal or mechanical processes.

In alternative embodiments, charcoals, activated charcoals, coal and other carbonaceous substrates, may be used in place of, or in addition to, biochar 10. The charcoals, activated charcoals, coal and other carbonaceous substrates may be modified with metal salts, or other chemical or physical processing, or used in their native state. The exemplary embodiment illustrated in FIG. 1 shows biomass pyrolysis as a source of biochar 10 used in the wastewater treatment; however, in other embodiments, biochar 10 or other carbonaceous substrate may be commercially purchased.

Polyamine: As used herein, “polyamine” refers to a compound comprising two or more amine groups. Each amine group independently can be a primary, secondary, tertiary, or quaternary amine. Furthermore, the polyamine may include aliphatic amines, aryl amines, cycloaliphatic amines, amino sugars, or combinations thereof. In some embodiments, the polyamine is a polymer comprising two or more amines. The polymer may be a linear, cyclic or branched polymer. One or more of the amines may be protonated, such as in a “protonated amine.” The term “protonated amine” as used herein refers to an amine group including a proton or a hydrogen atom such that the amine group is positively charged. The polymer may include a primary protonated amine (e.g., RNH₃⁺), a secondary protonated amine (e.g., R₂NH₂⁺), a tertiary protonated amine (e.g., R₃NH⁺), or combinations thereof, wherein R is a C₁-C₁₂ aliphatic moiety, a C₃-C₁₂ cycloaliphatic moiety, or a C₅-C₁₂ aryl moiety. Exemplary polymers include, but are not limited to, polyalkylenemine, such as polyethyleneimine (PEI), polypropyleneimine, polybutyleneimine, polypentyleneimine, or combinations thereof; poly(vinyl amine); poly(4-vinyl pyridine); poly(2-(dimethylamino)ethyl methacrylate); poly(amido amine); polysaccharide, such as chitosan; or combinations thereof. In some embodiments, the polymer includes a protonated poly(vinyl amine), a protonated poly(4-vinyl pyridine), a protonated polyethyleneimine, a protonated poly(2-(dimethylamino)ethyl methacrylate), a protonated poly(amido amine) dendrimer, a protonated chitosan, or combinations thereof. In some embodiments, the polymer is or comprises a dendrimer, such as 1^{st}, 2^{nd}, 3^{rd}, 4^{th}, 5^{th}, 6^{th} or more generation dendrimer. Exemplary polyamine dendrimers include, but are not limited to, polyalkylenemine dendrimers, such as PEI dendrimer, polypropyleneimine dendrimer, polybutyleneimine dendrimer, polypentyleneimine dendrimer, or combinations thereof; poly(amido amine) dendrimer; or combinations thereof.

In certain embodiments, one or more amine groups of the polyamine compound are protonated amines.

In certain embodiments, the polyamine compound includes protonated polyalkyleneimine polymers. Suitable non-limiting examples of protonated polyalkyleneimines include protonated polyethyleneimine, protonated polypropyleneimine, protonated polybutyleneimine, protonated polypentyleneimine, or combinations thereof.

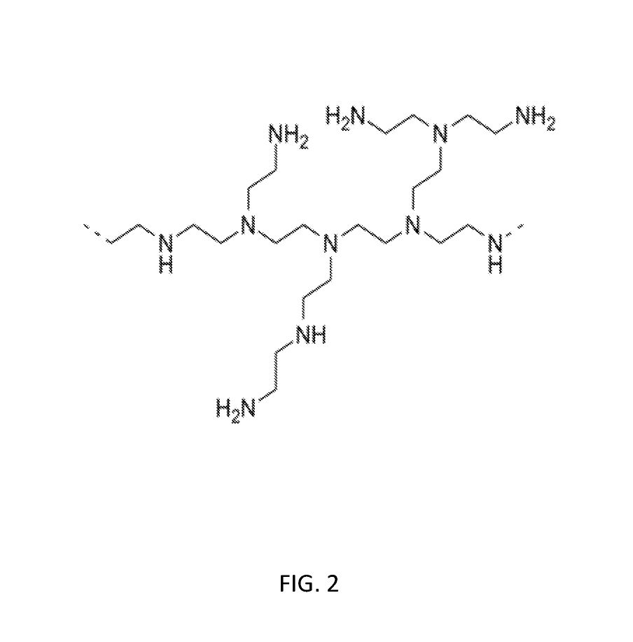

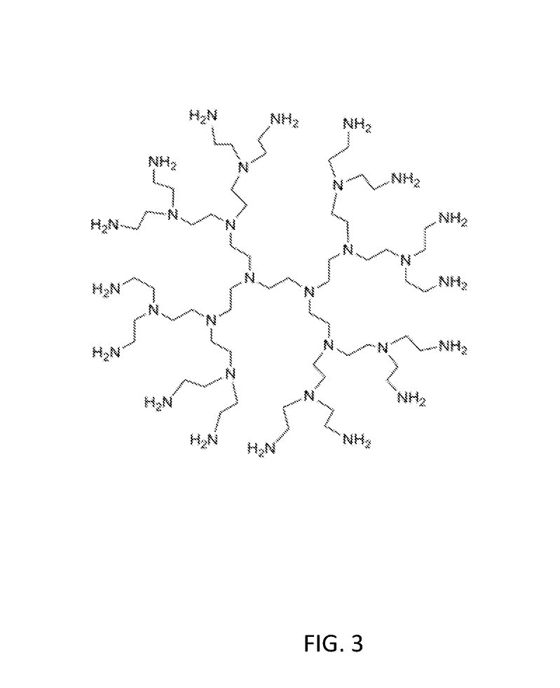

In certain embodiments, the polyamine compound is or comprises a PEI polymer. A PEI polymer may be linear, branched or hyper-branched, such as in a dendrimer. Certain PEI polymers may be represented by a repeating unit comprising an amine and a C₂ aliphatic (ethylene) moiety, and may comprise from at least two such units to at least 150 units, such as from 2 units to 125 units, from 5 units to 115 units, or from 10 units to 105 units. In some embodiments, the amines are linked by C₂ alkyl chains. In some embodiments, a PEI has a degree of branching (DB) of approximately 65-70%, and may comprise primary, secondary, tertiary and/or quaternary amines. One example of a branched PEI fragment is shown in FIG. 2. PEI with various molecular weights ranging from about 600 to 60,000, as determined by standard techniques, such as size exclusion chromatography, are commercially available. In some embodiments, the PEI includes 15% to 25% primary amines, 20% to 50% secondary amines, and 10% to 25% tertiary amine moieties. The PEI may be a dendrimer, and may comprise primary and tertiary amines, and/or quaternary amines if the dendrimer is protonated. FIG. 3 provides the structure of an exemplary 4^{th} generation PEI dendrimer.

In some embodiments, PEI comprises protonated amines. In certain embodiments PEI may include at least one primary protonated amine moiety, at least one secondary protonated amine moiety, at least one tertiary protonated amine moiety, or combinations thereof.

In some embodiments, the polyamine is or comprises chitosan. Chitosan is a polysaccharide comprising amino sugars, such as D-glucosamine, N-acetyl-D-glucosamine, and combinations thereof. Chitosan is both biocompatible and biodegradable. Typically, chitosan comprises β-(1-4)-linked D-glucosamine and N-acetyl-D-glucosamine that are randomly distributed throughout the polysaccharide. In some embodiments, the degree of deacetylation in chitosan is from less than 60% to 100%, such as from 60% to 100%, from 60% to 98%, from 65% to 95% or from 75% to 85%, where 60% deacetylation refers to a chitosan where 60% of the amino sugars are D-glucosamine and 40% are N-acetyl-D-glucosamine. The degree of deacetylation can be determined by any suitable technique known to a person of ordinary skill in the art, such as NMR. Chitosan typically has a molecular weight of from less than 3,800 Daltons (Da) to 375,000 Da or more, such as from 3,800 Da to 310,000 Da. In some embodiments, chitosan has a molecular weight of from 3,800 Da to 20,000 Da, from 50,000 Da to 190,000 Da, from 190,000 Da to 310,000 Da, or from 310,000 Da to 375,000 Da or more, as determined by viscosity. Chitosan can be made by treating crustacean shells, for example, from shrimp, with an alkali, such as a metal hydroxide, particularly sodium hydroxide.

Biochar surface modification with polyamine. The biochar may be mixed with one or more polyamine compounds, such as a polyamine polymer or dendrimer, particularly PEI, to modify the surface of the biochar. The polyamine compound may be attached to the biochar surface by any suitable method of attachment, such as covalent bonding, absorption, adsorption, or electrostatic attraction. In certain embodiments, biochar with adequate native surface binding properties for good adsorptive and/or ion exchange adhesion and modification is used.

In some embodiments, the biochar is pretreated with acid, such as a mineral acid such as hydrochloride acid, sulfuric acid, or nitric acid, organic acids such as lactic acid or acetic acid, or any combination thereof; alkali, such as sodium hydroxide, potassium hydroxide, sodium carbonate, or combinations thereof; or oxidizing agent, such as ozone. Typically, after treatment with an acid or alkali, the biochar is washed with water, such as deionized water, until the pH of the elution is around 7. The wet biochar is then dried and mixed with a polyamine for surface modification.

Additionally, or alternatively, the biochar may be treated with a crosslinking agent and/or a transesterification agent before introduction of the polyamine compound. The crosslinking agent and/or transesterification agent may be any crosslinking agent and/or transesterification agent suitable for facilitating attachment of the polyamine to the biochar. In certain embodiments, the crosslinking agent is an aldehyde, and may be a bis- or poly-aldehyde, such as glutaraldehyde. In certain embodiments, the transesterification agent is an alcohol-alkali mixture, such as a methanol-NaOH mixture. In certain embodiments, a polyamine, such as PEI and/or chitosan, with a low-to-moderate molecular weight is used. For example, PEI may be used that has a molecular weight of from 600 to at least 6000. Additionally, or alternatively, the polyamine, such as PEI and/or chitosan, is selected to have a suitable polydispersity index, such as from 0.2 to 1.5. The polyamine may be selected such that it will modify the carbon surface but not “fill” the desirable pores of the surface. In some embodiments, the polyamine, such as PEI and/or chitosan, comprises protonated amines. The reagent demand of the biochar and polyamine is the amount of each reagent, biochar and polyamine, required to achieve a desired water quality. The reagent demand can be estimated from the wastewater quality and nitrogen compound, such as nitrate or ammonia, concentration, and/or by nitrate and/or ammonia removal optimization trials. The reagent demand of the biochar and polyamine can be adjusted by manual or automatic process, or combinations thereof, to address the level of contamination and water quality characteristics of the solution to be treated.

Batch slurries of micronized biochar, with a particle size <1 mm, are mixed with sufficient polyamine to address the removal needs of the target water dictated by nitrogen compound, such as nitrate or ammonia, concentration and the mass biochar dosing rate into the water. Since polyamine binding to the biochar may be influenced by adsorptive and ion exchange surface chemistries, the chemical properties of the treated water should be considered, especially pH, as a sharp increase or decrease in pH may release the adhered polyamine. Although this is not a problem with most water treatment applications, process testing for stability of the biochar-polyamine complex may be advantageous for water treatment reagents that impact solution pH or direct modification of pH. Preprocessing of the biochar surface by chemical oxidation, such as by ozonation, acid treatment or alkali treatment may facilitate enhanced adsorptive capacity of biochars without the native surface functionality for good polyamine adhesion in water treatment applications.

Polyamine-modified biochar can be a substrate for an Enhanced Efficiency Fertilizer (EEF) whereby the chemical affinity of nitrate for the substrate limits dissolution. This can limit the potential for groundwater leaching or surface runoff, while maintaining the plant nitrogen (or nitrate) uptake potential in the rhizosphere. Biochar also addresses additional soil quality issues such as moisture retention, favorable soil microbial activity, macro and micro plant nutrient retention, and the potential for general agronomic productivity enhancement. This is agricultural benefit is in addition to the carbon sequestration afforded by the application of charcoal to the soil.

In certain embodiments, a biochar-polyamine mixture is used to recover trace precious metals and/or rare earth metals from wastewater streams with reactive filtration (RF). Without being bound to a particular theory, the recovery may be due to the complexation capability of certain polyamines towards some cationic metals or metalloids. In some embodiments, the polyamine compound useful for recovering precious metals and/or rare earth metals is a PEI polymer and may be a PEI dendrimer. In other embodiments, the polyamine compound useful for recovering precious metals and/or rare earth metals is chitosan.

Certain embodiments include methods to remove nitrate from solutions. Embodiments of the method may comprise premixing biochar with one or more polyamines to modify the surface of the biochar, and contacting the solution with the biochar-polyamine mixture to bind at least a portion of the nitrate ions in the solution. The method may also include separating at least a portion of the polyamine-nitrate complex from the solution. In some embodiments, the polyamine compound is a PEI polymer and/or chitosan, and may comprise one or more protonated amines. In other embodiments, the polymer is chitosan and the biochar/chitosan combination removes ammonia from the water.

By addition of a polyamine, the water treatment process, described in US patent application No. 2015/0144564, incorporated herein by reference, can be converted to a nitrate removal process applied with or without the Fe-modified biochar used in the phosphate removal aspect of the process. In some embodiments, 1 gram of PEI-modified biochar per liter of nitrate-fortified water resulted in at least 50% removal of the nitrate from the solution. In some embodiments, two RF processes, one for phosphate removal and one for nitrate removal may be useful. In other embodiments, it is advantageous to form a single water treatment reagent comprising a nitrate removal biochar and a phosphate removal biochar. RF recovery of the modified biochar with co-reacted nitrate and/or phosphate removed from the treated water creates a nitrate and/or phosphate upcycled biochar substrate suitable for agricultural application. The relative amounts of nitrate and/or phosphate in the biochar matrix varies with wastewater type. For example, dairy wastewaters with high nitrate (tens or hundreds of milligrams per liter) and/or phosphate (tens or hundreds of milligrams per liter) would yield relatively higher recovered biochar absorbed nitrate and/or phosphate values), but solution nitrate and/or phosphate values in the lower concentration range (for example 0.5 to 10 milligrams per liter) would yield recovered biochars with a lower recovered total P or N concentration. The presence of a PEI polymer, a GRAS (generally regarded as safe) substrate, increases recoverable nitrate value to the biochar residual.

### A. Wastewater Pathway

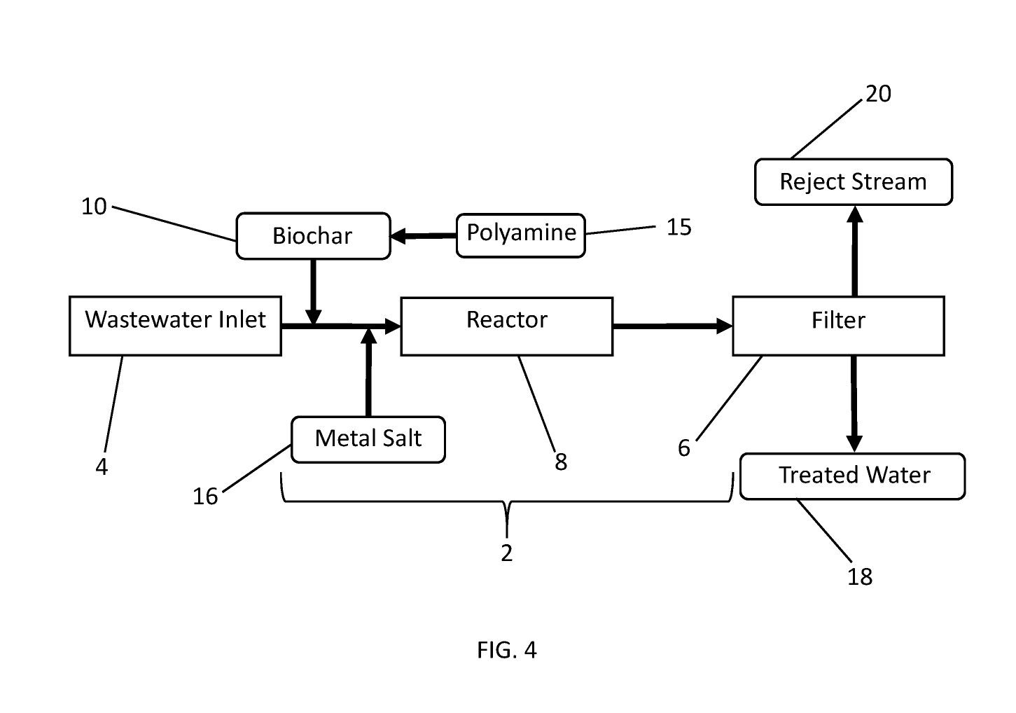

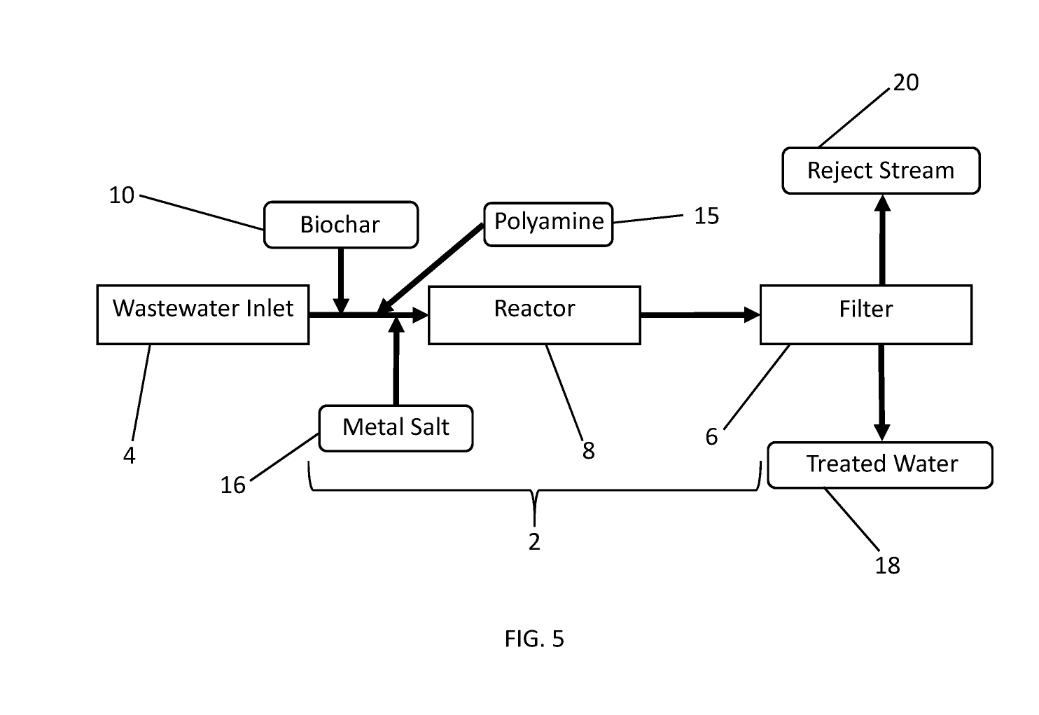

FIG. 4 provides a schematic diagram of one embodiment of a disclosed wastewater treatment apparatus. With reference to FIG. 4, wastewater enters a wastewater flow pathway 2 from a wastewater inlet 4. As used herein, the term “wastewater” refers to any water to be treated. Wastewater may be, but is not necessarily, highly contaminated water such as raw or minimally processed municipal sewage or livestock manure lagoons, or more process wastewater often called secondary wastewater that has been subjected to some chemical or microbial treatment. Wastewater may contain only trace amounts of phosphorus, nitrogen-containing contaminants including nitrates, metals or other contaminants such as organic or inorganic contaminants, in single or mixed solution. The contaminants may be dissolved and/or suspended. The wastewater may contain substances of known or unknown risk to human health and environmental quality, or substances to be recovered for use, reuse or recycling. Wastewater may come from any source, including, but not limited to industrial, agricultural, municipal, or natural source, or any combination thereof. Examples of target contaminants include but are not limited to: Hydrocarbons, such as polycyclic aromatic hydrocarbons (PAHs), which arise from water contamination in petroleum or natural gas operations; mercury, including methyl mercury and other organomercurials, such as in municipal and coal energy wastewater; other heavy and/or toxic metals, such as arsenic; pathogenic microbial cells, such as Escherichia coli, from human and animal wastewaters; phosphorus- and nitrogen-containing compounds, including nitrates, and salts; and hormonally active chemicals and human and veterinary pharmaceuticals, and their metabolites, from human and animal wastewaters. The wastewater inlet 4 may be directly fluidly connected to one or more sources. Alternatively, wastewater inlet 4 may be connected to a reservoir or tank that is directly or indirectly supplied from the source(s). The wastewater flow pathway 2 connects the wastewater inlet 4 to a filter 6, and comprises a reactor region 8. In some embodiments, biochar 10 premixed and/or modified with polyamine 15 is added to the wastewater along the wastewater flow pathway 2. In other embodiments, biochar and the polyamine are added separately to the wastewater, either sequentially in any order, or simultaneously through the same or different inlets. FIG. 5 shows an alternative embodiment comprising sequential addition of biochar 10 followed by polyamine 15, but a person of ordinary skill in the art will appreciate that the order of addition can be reversed.

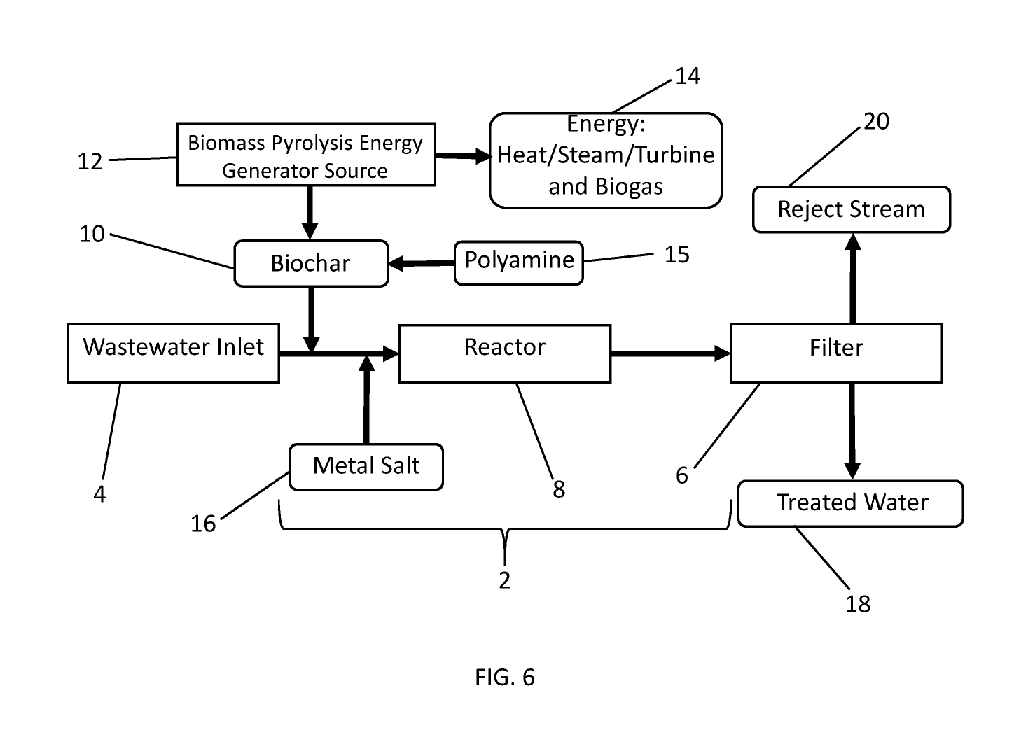

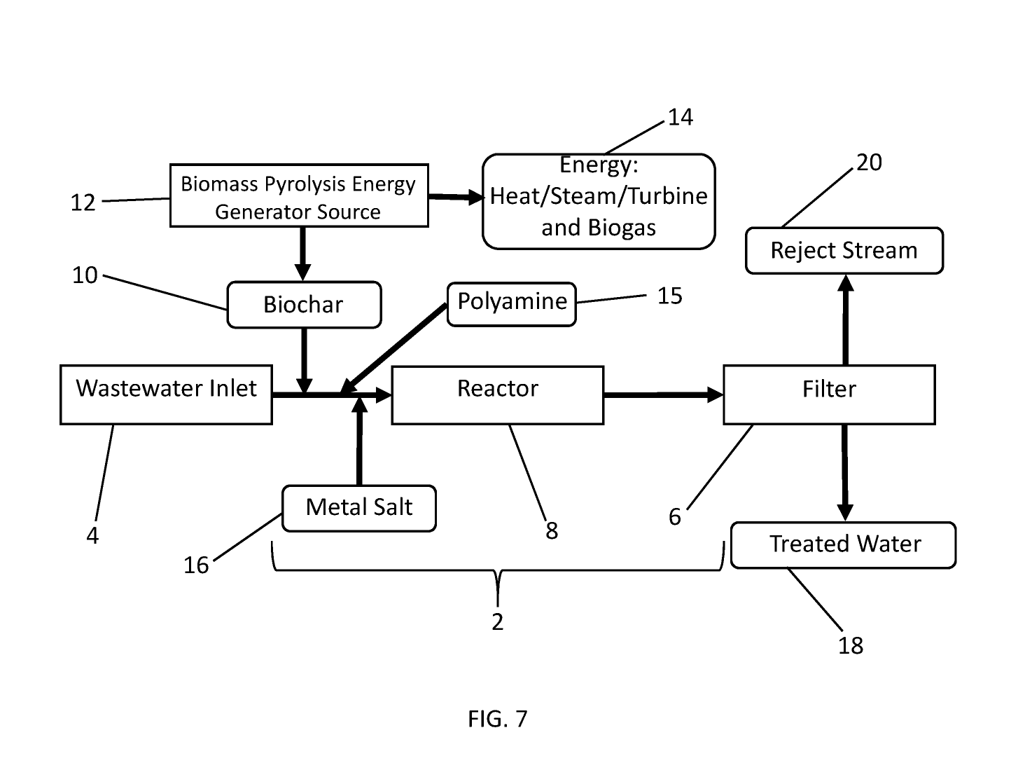

Biochar 10 may be generated offsite, such as by a pyrolysis or hydrothermal process according to FIG. 1, or biochar 10 may be generated onsite, for example, as shown in FIGS. 6 and 7. With respect to FIGS. 4-7, the biochar and/or polyamine-modified biochar may be added to the wastewater in the wastewater flow pathway 2 as a dry material, as a fluid slurry or suspension, or both. Biochar 10 can be added to the wastewater at a concentration appropriate to the contamination level of the wastewater, and the desirable and/or optimum operation of the reactor 8 and filter 6. Biochar 10 can be added to the wastewater by any suitable means such as, but not limited to, a hopper and auger, mixing basin, direct injection aided by air pressure, venturi effect, fluid pressure, or any combination thereof. Biochar 10 can be mixed into the wastewater with a variety of devices, including, but not limited to, static mixer using a tortuous path, active mechanical mixing, energetic mixing, or any combination thereof.

Adsorption of many chemicals on biochar 10 and other carbonaceous substrates is typically in the range of milligrams to hundreds of milligrams per gram of the carbonaceous substrate. Many wastewaters contain levels of contaminants not exceeding tens or hundreds of milligrams per gallon. Therefore, in some embodiments, biochar 10 and/or other carbonaceous substrates are added to the wastewater treatment in an amount of from greater than zero to greater than two grams of material per gallon of wastewater treated in the process, such as from one milligram to two grams, or from five milligrams to one gram.

With reference to FIGS. 4-7, the reactor 8 can be any reactor suitable for mixing wastewater with any materials added to it. In some embodiments, mixing is achieved by physical and/or energetic stirring or other agitation, generating or increasing turbulence within the flow or a combination thereof. In certain embodiments, the reactor is a plug flow reactor, and may be a serpentine plug flow pipe reactor. A person of ordinary skill in the art will appreciate that optimum mixing and reaction times for the reactor 8 will be determined by particular wastewater chemical characteristics, including, but not limited to, pH and hardness. For example, the length and diameter of a plug flow reactor will be selected to provide the optimum mixing and reaction times based on the characteristics of the particular wastewater stream that will flow there through.

In some embodiments, such as the exemplary embodiments shown in FIGS. 4-7, a metal salt 16 is added to the wastewater flowing in the wastewater flow pathway 2. The metal salt may be added as a solution, such as an aqueous concentrate; as a dry solid reagent, such as a powder or granules; as a slurry or suspension; or combinations thereof. The metal salt can be any metal salt suitable for treating or purifying the water such as by reacting with contaminants in the water, activating the biochar, facilitating precipitation of contaminants in the water and/or any other mechanisms for removing contaminants. In some embodiments, the metal salt comprises iron, aluminum, calcium, magnesium, manganese, zinc, copper or a combination thereof, and in particular embodiments, the metal salt comprises iron. Common iron metal salts include ferrous, ferric cations, and ferrate anions. Other suitable cations include, but are not limited to, sodium, potassium, calcium and magnesium. Suitable anions include, but are not limited to, common soluble anions such as chloride, bromide, iodide or sulfate. In some embodiments, the metal salt comprises ferric chloride, ferrous chloride, ferric sulfate, ferrous sulfate, aluminum chloride, aluminum sulfate, potassium aluminum sulfate, aluminum hydroxide, or any combinations thereof. In certain embodiments, the metal salt is a ferric halide, such as ferric chloride.

Iron metal salts can form a reactive filtration substrate on surfaces that adsorb iron oxyhydroxides and iron cations from mixed solution. U.S. Pat. Nos. 7,399,416 and 7,713,423, incorporated herein by reference, disclosed exploiting this property in the reaction of the iron oxyhydroxides spontaneously forming and adsorbing to create a reactive surface coating on the sand substrate in a moving bed sand filter, thus creating a reactive filter. In contrast, in the exemplary embodiments of the system and process described in FIGS. 4-7, a solid carbonaceous substrate with desirable native properties to adsorb contaminants from wastewater, for example biochar 10, is added and mixed with the wastewater. The solid carbonaceous substrate then reacts in that wastewater with a solution of the metal salt 16, for example an iron salt solution. The carbonaceous substrate adsorbs and chemically binds a portion or the totality of the added metal salt. This forms a modified solid carbonaceous substrate in the wastewater from a rapidly forming and renewable oxide coating, such as a hydrous ferric oxide coating. However, active carbon-carbon adsorptive sites normally associated with the desirable use of carbonaceous substrates, for example activated charcoals, are still preserved for water treatment. The surface-modified carbonaceous substrate comprises regions of increased ionically charged or polar reactive sites from the adsorption and/or binding of the metal. This facilitates removal of a greater range of contaminants from wastewater than a solid carbonaceous substrate or metal salt used in isolation. Once adsorbed and/or bound to the modified solid carbonaceous substrate, the contaminants may be removed from the wastewater by physical and/or chemical separation processes. In some embodiments, balancing the biochar 10 and iron salt 16 additions with regards to subsequent reaction and mixing in the reactor 6 can enable preconditioning of the reactive matrix of iron modified biochar 10 and residual iron oxyhydroxides in the flowing wastewater. This preconditioning may allow the reactive matrix to retain its reactive ability throughout the treatment process and over the full length of the water pathway and into the subsequent filter 6. The wastewater therefore is dynamically treated for contaminant removal throughout the wastewater flow pathway 2. The solid reactive matrix of iron modified biochar 10 and residual iron oxyhydroxides in the flowing fluid can modify the sand surface and the sand bed itself in the filter, both chemically and physically, to create a reactive filter.

Typical concentrations of the metal, such as iron, added as the metal salt 16 are in the range of from greater than 0 to greater than 100 milligrams of metal per liter of wastewater, such as from 1 to 50 milligrams or from 1 to 25 milligrams. However, in some embodiments, it may be operationally advantageous to add less or more of this reagent depending on specific wastewater characteristics and desired contaminant removal. In certain embodiments, addition of an iron metal salt solution to the wastewater with added non-soluble solid biochar 10 allows for the adsorption of iron onto the carbonaceous substrate particulates.

Native and iron modified charcoals, activated charcoals, coal, carbonaceous substrates and biochars have numerous pores of varying sizes. This provides good porosities and surface area that depend on the specific material and method of preparation. High porosity allows for very high reactive surface area and thus very high surface reaction potential in native or modified forms. The lower relative density and hardness of carbonaceous substrates, such as biochar, compared to sand make them well suited for physical separation from fluids, such as by a moving bed reactive sand filter.

In certain embodiments, biochar 10, polyamine 15 and metal salts 16 are added to the wastewater pathway 2. Biochar 10, polyamine 15 and metal salt 16 can be added to the wastewater pathway 2 separately in any order, or alternatively they can be mixed in any combination and added to the wastewater pathway. As an exemplary embodiment illustrated in FIGS. 4 and 6, biochar 10 is premixed with polyamine 15 to form a biochar-polyamine mixture, and the biochar-polyamine mixture is then added into the wastewater pathway 2, followed by addition of metal salt 16. In certain other embodiments, such as those illustrated in FIGS. 5 and 7, biochar 10 is added to the waste water pathway 2, followed by the addition of polyamine 15, and optionally metal salt 16. In certain other embodiments, biochar 10 is premixed with polyamine 15 and added to the wastewater pathway after the addition of metal salt 16. In certain other embodiments, biochar 10 is premixed with polyamine 15 and added to the wastewater pathway 2 simultaneous with the metal salt. In certain other embodiments, biochar 10 is premixed with polyamine 15 and metal salt 16 and added to the wastewater pathway 2. Biochar 10 can be added before or after the reactor 8. Biochar 10 premixed with a polyamine 15 can be added before or after the reactor 8. Biochar 10 premixed with a polyamine 15 and metal salt 16 can be added before or after the reactor 8. Polyamine 15 can be added before or after the reactor 8. Metal salt 16 can be added before or after the reactor 8. In certain embodiments, the polyamine comprises a polytertiaryamine compound. In certain other embodiments, the polyamine comprises a PEI polymer, such as a dendrimer. And in other embodiments, the polyamine comprises chitosan.

Certain embodiments premix the biochar 10 with polyamine 15 and a concentrated metal salt solution to form a slurry. This slurry is added to the wastewater pathway prior to the reactor 8. This embodiment is advantageous in some circumstances, since the very acidic pH of concentrated metal salt solutions can activate carbonaceous substrates by increasing porosity and chemical functional groups. For example, a 40% weight-volume iron chloride saturated solutions has a pH of about 2. These acidic solutions have the ability to activate the surface of charcoals.

Certain embodiments premix the biochar 10 with a concentrated metal salt 16 solution to form a slurry. This slurry is added to the wastewater pathway before or after addition of polyamine 15 prior to the reactor. Premixing biochar 10 with a concentrated metal salt solution is advantageous in some embodiments because it eliminates the manufacturing step of producing an activated carbonaceous substrate. Activating the biochar 10 in situ is advantageous to overall engineering efficiency and lower operating costs, while increasing the reactive adsorptive efficiency of the carbonaceous substrate.

In an alternate embodiment, a metal salt is not added to the wastewater pathway 2. In certain embodiments, only biochar 10 or another carbonaceous substrate and polyamine 15 are added to the wastewater pathway 2 prior to the reactor 8. In certain embodiments biochar 10 is premixed with a polyamine 15 and only the biochar-polyamine mixture added to the waste water pathway.

In any of the above embodiments, an oxidant may be added to the wastewater pathway. The oxidant can be any oxidant suitable for removing a contaminant from the water, killing and/or inhibiting the growth of a pathogen in the water, sterilizing the water, or any combination thereof. The oxidant may destructively remove a contaminant such as an organic compound, hormone, antibiotic or pathogen. In some embodiments, the oxidant is selected from ozone, oxygen, peroxides, persulfates, permanganates, perchlorates, chlorates, chlorites, hypochlorites, fluorine, chlorine, bromine, iodine, or any combination thereof. In certain embodiments, the oxidant is ozone, potassium permanganate, sodium hypochlorite, or hydrogen peroxide. The oxidant may be added before or after the addition of biochar 10, charcoals, activated charcoals, coal and other carbonaceous substrates, before or after the addition of the polyamine 15, before or after the addition of biochar-polyamine mixture, and/or before or after the addition of the metal salt 16, such as an iron metal salt solution, if present. The oxidant may be added upstream of the reactor 8 or downstream of the reactor 8. Alternatively, the oxidant can be added to the wastewater pathway in the reactor 8. Activated carbon can transform ozone into highly reactive hydroxyl radicals capable of reacting with many contaminants of concern. Carbonaceous substrates, such as activated carbon and biochar, adsorb non-polar chemicals, such as PAHs. This surface binding may be advantageous for the catalytic oxidation of many organic chemicals. Thus, it is advantageous to add carbonaceous substrates, especially an inexpensive byproduct such as biochar, to water for the purposes of catalytic oxidation to react with and/or otherwise remove potentially toxic chemicals of concern. The combination of biochar and oxidant, such as ozone, can also remove pathogens from the wastewater. In some embodiments, a biochar/polyamine/oxidant combination, optionally including a metal salt, can contribute to a substantially sterilized water stream, such as by destructively removing pathogens from the water.

In alternate embodiments, the ozone is added before or after the addition of biochar or other carbonaceous substrate and polyamine 15, without the addition of the metal salt 16. In alternate embodiments, the ozone is added before or after the addition of biochar or other carbonaceous substrate and polyamine 15 mixture, without the addition of the metal salt 16.

In other examples, an additional organic carbon compound, for example an alcohol, a saccharide, a cellulose derivative, or a combination thereof, is added to the wastewater pathway 2, before or after the addition of the carbonaceous substrate, such as biochar, charcoal, activated charcoal, or coal, and polyamine 15, with or without addition of the metal salt 16. The saccharide may be a monosaccharide, disaccharide, trisaccharide, tetrasaccharide, polysaccharide, or a combination thereof. In some examples, the additional organic carbon compound is methanol, ethanol, ethylene glycol, glycerol, acetate, glycerin, glucose, galactose, maltose, fructose, hydroxyethyl cellulose, hydroxypropyl cellulose, carboxymethyl cellulose or a combination thereof. The additional organic carbon compound can act as a feedstock to promote microbial denitrification or dissimilatory nitrate reduction within the reactor bed to facilitate removal of nitrogen compounds from the wastewater. Denitrification is the microbially driven reduction of oxidized forms of nitrogen, such as nitrate, into reduced forms and finally to nitrogen gas, as a result of respiratory processes. Dissimilatory nitrate reduction to ammonium is accomplished by certain microorganisms with the genetic make-up for this metabolic action.

### B. Filtration System

Referring again to FIGS. 4-7, after mixing and reacting in the reactor 8, the wastewater in the wastewater flow pathway 2 continues into the inlet of a filter 6. The filter 6 can be any filter suitable to separate a treated water stream 18 from a reject stream 20. In some embodiments, the filter 6 comprises a moving bed filter, a continuously moving bed filter, moving bed reactive filter, a continuously moving bed reactive filter, a cycled backwash filter, fluidized bed filter, agitated bed filter, horizontal flow bed of the filter substrate, membrane filter, disk filter, cloth filter, or other filter mechanically, physically, or energetically moved. A preferred embodiment uses a sand bed; however, alternate particulate filtration media, natural or synthetic, may be used instead. Examples of alternate solid filtration media in the reactive filter bed include, but are not limited to, anthracite coal, garnet sand, natural or synthetic minerals, polymeric or plastic beads, or synthetic substrates including carbonaceous substrates.

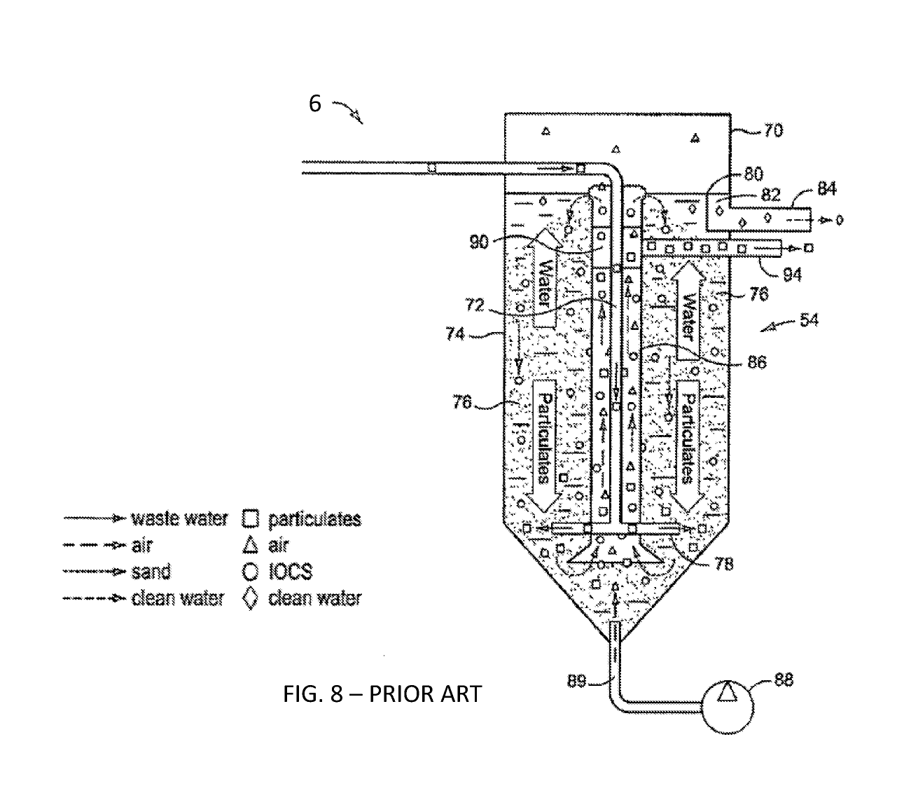

In some embodiments, filter 6 is a continuously moving bed reactive sand filter. Exemplary reactive filtration configurations are described in U.S. Pat. Nos. 7,399,416 and 7,713,423, both incorporated herein by reference, and one exemplary embodiment is illustrated in FIG. 8. Briefly, the wastewater enters the continuously moving bed reactive sand filter 6 in an upwards flow, initially from the bottom of the sand bed 76, by means of a central distribution assembly of concentric pipes. One pipe 72 provides inlet down flow of wastewater to the bottom of the sand bed. An additional pipe 86 includes a directional cone for capturing rising air bubbles inserted into the very bottom of the sand bed from an external air compressor 88. The sand 76, water, and filter contaminant slurry rise into the central column assembly in the filter 6. This wastewater distribution assembly discharges the inlet wastewater through the lower fluid assembly 78 into the near bottom of the sand bed for upwards flow through the sand bed 76. This system allows for downward flow movement of the sand bed resulting from air bubble in-flow from an inlet 89 at the base of the sand column connected to an air compressor 88 in the bottom of the central assembly pipe, below the inlet 78 wastewater distribution into the bed. Air under pressure from the inlet 89 enters the saturated sand bed. The rising action of the bubbles force a slurry of sand, filter particles, and air to rise in the central assembly and to the washbox 90. In some embodiments, washbox 90 is a tortuous flow washbox. The washbox 90 provides for gravity and hydraulic flow driven density separation of the denser sand from the less dense filtered particulates, which continue in the hydraulic flow to be discharged as a filter reject through outlet 94. The denser sand falls from the washbox 90 into the main part of the sand bed, and is rinsed with a small portion, for example 5%, of the filtered water up flowing from the sand bed and channeled to join the particulate reject flow for discharge. The up flowing filtrate, exiting from the top of the sand bed, pools above the sand bed and drains into stilling well 80 and is discharged from the reactor as cleaned water. As described in U.S. Pat. Nos. 7,399,416 and 7,713,423, iron salts added to the wastewater flow may result in the formation of reactive hydrous ferric oxides that suspend in solution and adhere to the sand in the sand filter bed creating a reactive iron coated sand before being removed by the abrasive action of moving sand further down in the moving sand filter bed.

Referring again to FIGS. 4-7, a highly advantageous feature of the system and method disclosed herein is the addition of a solid carbonaceous reactive substrate to the wastewater in the wastewater pathway 2, and have the flowing, mixed, and reacted substrate subsequently injected directly into the lower portions of the sand bed filter 6. The abrasive action of the inter-grain motion of the moving sand, and the very high forces in the lower bed resulting from the mass of sand in the upper region of the bed in a moving bed reactive sand filter 6, has a desirable “flour milling” effect on the solid carbonaceous reactive substrate, such as granular, pulverized, or powdered biochar 10, suspended in the wastewater entering the filter bed. This result happens because the material hardness of typical quartz sand in the filter is typically several times greater than biochar and most charcoals, activated charcoals, coal and other carbonaceous substrates. For example, the Mohs hardness of quartz sand is about 7 and the Mohs hardness of activated charcoal is typically less than 3. Thus, this hardness differential allows for crushing and grinding of the carbonaceous substrate in the lower moving sand bed. This decreases particle size and increases reactive surface area to further remove contaminants from the wastewater in the process. The added material can then also act as a dynamic filter aid by decreasing the net pore size of the sand filter bed as the biochar 10 moves downward, thus retaining smaller contaminant particles and increasing overall filtration efficiency.

This dynamic pulverization of the solid carbonaceous substrate within the downwardly moving reactive bed provides a greatly increasing reactive surface area per mass, and a zone of downwardly moving, decreasing permeability in the lower portion of the moving sand bed. And polyamine 15 can act as a polymer that can bind smaller particles, typically anionic particles. This is an advantageous result that significantly increases the removal of suspended contaminant particulates and dissolved contaminant chemicals. Indeed, one of the challenges in sand filtration of contaminated waters is the formation of gelatinous layers on or around the sand media, often called biofilms, Schmutzdecke, or hypogeal layers. While slow or static sand filter beds for water treatment may benefit from these biofilms for increasing treatment efficiency by biologically removing or degrading some water contaminants, Schmutzdecke can also function to build up and fill the inter-grain pores of the sand bed. This occurs by the action of the microbes and filtered particles, forming a “glue” and cementing sand particles together in critical regions in the filter. This decreases permeability and permeate flow to unacceptable levels, and thereby reduces filter efficiency and operational consistency. Many bacteria form and excrete glue-like “adhesins,” exudate macromolecules that are commonly proteins or polysaccharides, to help them adhere to surfaces; these chemical “glues” help bacteria withstand high shear forces. One of the fundamental properties in adsorption science is “like-likes-like”. That is to say, charged chemicals “like” charged surfaces, and uncharged or non-polar chemicals “like” the uncharged or non-polar surface regions of carbon substrates, for example biochar or charcoals. The addition of carbonaceous substrates into the sand bed helps provide an alternate and, for many biochemical adhesins, a more active “like-likes-like” bacterial carbon compound for receiving adhesins. Accordingly, the overall sand filter operation is not as likely to fail from cementation or buildup of Schmutzdecke. One highly desirable result of adding native or iron modified biochar, or other carbonaceous substrates, is that biofilm and Schmutzdecke buildup is minimized as the added carbonaceous substrate particles are readily removed from a moving bed sand reactor in normal filter operation. At the same time, desirable biofilm production, such as in the case of cultivating and feeding denitrifying bacteria for nitrogen removal from the wastewater, is possible within the numerous pores of the biochar material within the sand bed. These spaces provide a physical region and refuge for desirable denitrifying bacteria, sheltering them from predator microorganisms such as protozoa. These novel actions of biochar within the moving sand bed are significantly advantageous developments in increasing filter efficiency and operational efficiency of removal of suspended contaminant particulates and dissolved contaminant chemicals.

Referring to FIG. 8, an up flow moving bed reactive sand filter 6 discharges the up flowing reacted and filtered, and now treated, water 82, countercurrent through the downward moving sand bed that acts to carry removed particulate to the lower portion of the bed. This treated water 82 is removed by hydraulic flow into a stilling well after pooling above the downwardly moving sand bed. In typical operation, cleaned sand falling from a tortuous flow washbox 90 by gravity action separates the sand from the reject water stream containing the filtered contaminants. Typical washbox configurations allow for a small portion of the up flowing clean treated water to be directed by hydraulic flow past the falling sand, enabling sand to be washed prior to falling onto the downwardly moving sand bed through the pooled treated water above the sand bed. The reject stream with solids, acting from the physical force of the rising air bubbles and resulting hydraulic flow in the central column assembly, continues in a separate pathway isolated from the contaminant-laden filtrate rising in the central assembly of the up-flow moving bed reactive sand filter 6. Treated water 82 is discharged from the moving bed reactive sand filter 6 and may be suitable for reuse, recycling, or discharge into the environment.

Filter aids can be used to enhance micro particulate separation from liquids. Filter aids are usually highly porous media added to liquids to increase separation efficiency. Filter aids are added to a liquid prior to mechanical or physical filtration processes. Their high porosity and ability to be added in a dynamic manner make filter aids desirable for separations. Filter aids help maintain porosity in some filtration operations; however, their use is mainly limited to clarifiers and vacuum filtration across a permeable flat filter. Filter aids are disadvantageous in static column filters since they will load up the initial filter bed region and decrease filtrate permeability. Diatomite, perlite and cellulose are common materials used as filter aids. Although diatomite is a widely used filter aid, many organic materials, such as potato starch particles, cotton fibers and solid polymers, are also used. The char and ash from combustion of some biomass materials such as rice hull can be used as a filter aid.

With reference to FIG. 8, the sand in the region above and below the lower-bed water distribution 78 will contain higher amounts of the solid carbonaceous substrate added to the flowing wastewater. This region can be further illustrated as a discrete horizontal sedimentary zone within the sand bed where the black carbonaceous substrate creates a reactive zone within the lower part of the moving sand bed. This discrete zone is dynamic because new carbonaceous substrate is entering the sand bed from the in-flowing wastewater. This in-flux is dynamically balanced by the out-flux in the normal moving bed sand reactor 54 by particulate removal in the lower bed by the rising air, sand, particulate and water slurry. This discrete zone now becomes highly reactive for contaminant adsorption because the dilute suspension of the carbonaceous substrate prior to entering the moving sand bed reactor has been concentrated and fixed into the pores of the moving sand bed. And permeate flow is forced across the reactive surfaces of the carbonaceous substrate.

By the action of the upward flowing water and the slow downward moving sand shown in FIG. 8, at, for example, a few inches per hour, the carbonaceous substrate particles create a dynamic reactive zone within the lower moving sand bed. It is advantageous to have such a dynamic reactive zone to enhance the removal of soluble and suspended water contaminants at high efficiency, as a result of decreased porosity in the sand bed by the carbonaceous substrate and the coupled reactive surface. While filter bed plugging is often an operational challenge in water treatment, the lower density and lower hardness, as well as the solid, insoluble structural integrity of carbonaceous substrates such as biochars and chars, affords a desirable non-caking or non-cementing action in most common wastewaters. A highly reactive filtration gradient is thus established in the zone of the moving bed. A steady state is achieved in the reactive zone by the downward motion of the sand removing carbonaceous substrate particles, and input of new carbonaceous substrate at inlet 78. This steady state stabilizes the reaction zone. Thus, the moving bed sand filter 6 has the advantageous feature that the reactive filter media is continuously added to the flowing fluid, subsequently pulverized within the moving sand to increase reactive surface area, and then discharged with the normal particulate removal action of the moving bed sand filter.

### C. Reject Stream and Solids Separation

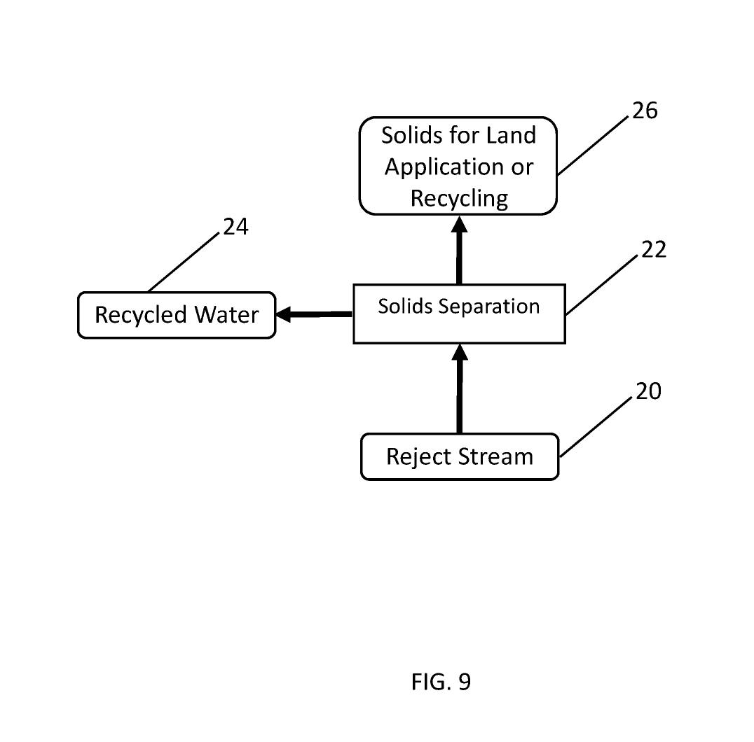

Referring to FIG. 9, the reject stream 20, which may include solids, is discharged from the filter 6 and is introduced to a solids separator 22. The reject stream 20 contains separated suspended water contaminants and filtered polyamine modified biochar particulates, and optionally may also contain polyamine- and metal-modified biochar, and/or metal oxyhydroxides. The metal may be iron, aluminum, magnesium or a combination of thereof. The solids separator 22 separates the reject water stream 20 into a recycled water stream 24 and a solid by-product stream 26. The solid by-product stream 26 may be a solid product or it may be a slurry or suspension of a solid in water. Stream 26 may be suitable for disposal, land application, or recycling. The recycled water stream 24 may be suitable for water recycling or further water treatment. The solid separator 22 can comprise a variety of mechanical, physical, chemical and/or energetic separators, and may include a settling basin, mesh filtration, membrane filtration, cloth filtration, sand filtration, rotating mat filtration, chemical coagulation, polymer addition, centrifugal force separation, sieving, magnetic separation, plate or basin clarifiers, coalescence separation, other process appropriate to the task, and any combination thereof.

Solids 26 may contain valuable resources that can be reclaimed, reused, or recycled, directly or indirectly through further processing, and thus may be used for disposal, land application, or recycling. An example of this is the removal of nutrient phosphorus as phosphates and/or nitrogen as nitrates from municipal, industrial or agricultural waste streams. These phosphates and/or nitrates may be recycled and/or reused as a fertilizer in agronomic applications. In some examples, the phosphates and or/nitrates are recycled and/or reused on agricultural, silvicultural, residential, commercial, or municipal land, or in horticultural soil containers. Phosphorus adsorbed to iron modified biochar and/or nitrogen absorbed to polyamine modified biochar in such a fertilizer has desirable slow release activity. Additionally, the biochar substrate provides advantageous soil conditioning properties and supports bioenergy production combined with carbon capture and storage (BioCCS) technology. This BioCSS may mitigate climate change from atmospheric carbon dioxide and other greenhouse gases. Furthermore, the solids 26 containing polyamine modified biochar may help retain soil nutrients, such as phosphorus and nitrogen, in agricultural areas where the nutrients may otherwise be mobilized in surface runoff waters and subsurface infiltration waters, with the undesirable effect of increasing nutrients in surface waters and ground water. Nutrient pollution in surface water can lead to eutrophication and the creation of large scale water quality impacts including dead zones. In ground water, nitrogen pollution can create a risk to human health from nitrate toxicity.

An additional feature of the system described above and as exemplified in FIGS. 4-7 and 9 is that it enables the co-manufacturing of a polyamine modified biochar-based agricultural fertilizer product that is safer in use and transport, more easily applied, and better suited to the channels of trade and distribution in commercialization than unprocessed biochar alone. In some embodiments, the polyamine modified biochar-based agricultural fertilizer product is a PEI-modified biochar-based agricultural fertilizer product. In other embodiments, the polyamine modified biochar-based agricultural fertilizer product is a chitosan-modified biochar-based agricultural fertilizer product. The system may advantageously process the polyamine modified biochar by the action of the water, the optionally added metal salts, such as iron metal cations, and any dissolved or suspended chemical, mineral, or microbial detritus. These factors change the chemical and physical properties of the biochar-enhanced filtrate solids, such that their further use as a practical and efficacious agricultural fertilizer is enhanced. A common problem with unmodified biochar is that it can be friable. Friable biochar produces a fine dust that can decrease air quality, and thus threaten human health and environmental quality. This undesirable property makes field application of unmodified biochar as a soil amendment difficult, potentially hazardous, and dirty. In addition, since the very dry unmodified biochar product is only partially combusted, it remains flammable, and thus is a hazardous material to transport. The common practice to reduce the hazard is to wet the biochar in transit. The solids 26, which contain a biochar residual, are already wetted, for example at 50% w/w. In addition, many wastewater types, including but not limited to, municipal wastewater, wastewaters from animal agriculture, and water following anaerobic digestion of waste material in syngas production, contain significant total, suspended, and/or dissolved organic chemicals, many of which can be natural biopolymers, such as humic and fulvic acids. These can act as binders for the smallest air buoyant or dust forming biochar particles. The polymeric chemicals in the wastewater, or any natural or synthetic chemicals desirable for solids recovery and use, such as, but not limited to starch, common water treatment polymers, alum, alginic acid and carrageenan, can be added during the solids separation process 22. This addition affects not only efficient solids recovery, but provides for a densification and binding of the solids 26, which may increase their suitability for disposal, land application, or recycling. For example, this densification and binding can allow for “pelletizing” of the recovered solids at any desirable size. Pelletized biochar solids may have greater commercial distribution efficiency and agricultural fertilizer application efficiency than non-pelletized biochar, and in addition reduce the hazards associated with transport and use of native biochar and many other carbonaceous substrates. In some embodiments, the recovered solids are formulated into a form suitable for application to agricultural, silvicultural, residential, commercial, or municipal land or horticultural soil containers.

Additionally, or alternatively, the polyamine, such as PEI and/or chitosan, can also act as a binder for the biochar particles. Thus, polyamine-modified biochar is also safer and easier to transport than dry, unmodified biochar. Therefore, in some embodiments, biochar is produced and modified with polyamine offsite, and then transported to the wastewater treatment location for use in wastewater treatment, such as those illustrated in FIGS. 4 and 5.

### IV. EXAMPLES

The following examples as well as the figures are included to demonstrate preferred embodiments of the present disclosure. It should be appreciated by a person of ordinary skill in the art that the techniques disclosed in the examples or figures represent techniques discovered by the inventors to function well in the practice of the invention, and thus can be considered to constitute preferred modes for its practice. However, a person of ordinary skill in the art should, in light of the present disclosure, appreciate that many changes can be made in the specific embodiments which are disclosed and still obtain a like or similar result without departing from the spirit and scope of the invention.

### Example 1

In a laboratory test, water was fortified with 100 mg/L nitrate. PEI-modified biochar was added in an amount of 1 gram biochar per liter of water. The mixture was mixed well for three minutes and then filtered to remove the biochar. The filtrate was analyzed by selective ion electrode for residual nitrate in the solution. The analysis showed that about 50% of the nitrate was removed by the PEI-modified biochar.

The process is being scaled up to pilot scale for treatment of wastewaters such as municipal wastewater treatment plants and diary lagoons.

### Example 2

Biochar's ability to sequester ammonium ions may depend on the biochar biomass starting material, the temperatures for processing and any post-charring treatments such as oxidation by ozone or activation by acid or base. In a typical controlled study, ammonium-fortified water is prepared by adding 20 mg of ammonium salt per liter of water. From 1 to 10 grams of biochar is added and mixed with the water. Typically, the biochar adsorbs from 5% to 60% of the ammonium ions in these controlled studies.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A system, comprising:
a polyamine source;
a fluid flow pathway, comprising a wastewater inlet for introducing a wastewater stream to the pathway, one or more inlets for introducing biochar and a polyamine to the pathway at least one inlet being fluidly connected to the polyamine source, and a reactor;
a filter downstream of the reactor and the one or more inlets, the filter fluidly coupled to the fluid flow pathway;
a treated water outlet fluidly coupled to the filter;
a reject stream outlet fluidly coupled to the filter; and
a solids separator fluidly coupled to the reject stream outlet, the solids separator further comprising a recycled water outlet and a solids outlet.

2. A method, comprising:
adding biochar and a polyamine to a wastewater stream, the wastewater stream comprising at least one contaminant; and
separating the biochar, polyamine and at least one contaminant from the wastewater stream to produce a treated water stream and a reject stream.

3. The method of claim 2, wherein adding biochar and the polyamine to the wastewater stream comprises mixing the biochar and the polyamine together prior to adding them to the wastewater stream.

4. The method of claim 2, further comprising contacting the biochar with an acid, an alkali, an oxidizing agent, a crosslinking agent, a transesterification agent, or a combination thereof, prior to mixing with the polyamine.

5. The method of claim 4, wherein:
the acid is hydrochloride acid, sulfuric acid, nitric acid, acetic acid or a combination thereof;
the alkali is sodium hydroxide, potassium hydroxide, sodium carbonate, or combinations thereof;
the oxidizing agent is ozone;
the crosslinking agent is glutaraldehyde; and
the transesterification agent is an alcohol-alkali mixture.

6. The method of claim 2, wherein the polyamine is poly(vinyl amine), poly(4-vinyl pyridine), polyethyleneimine, polypropyleneimine, polybutyleneimine, polypentyleneimine, poly(2-(dimethylamino)ethyl methacrylate), poly(amido amine), chitosan, a polyethyleneimine dendrimer, polypropyleneimine dendrimer, polybutyleneimine dendrimer, polypentyleneimine dendrimer, poly(amido amine) dendrimer, or a combination thereof.

7. The method of claim 2, wherein the polyamine is a polyethyleneimine dendrimer.

8. The method of claim 2, wherein the polyamine is chitosan.

9. The method of claim 2, wherein adding biochar to the wastewater stream comprises adding an amount of biochar of from 1 milligram to 2 grams per gallon of wastewater.

10. The method of claim 2, wherein adding a polyamine to the wastewater stream comprises adding an amount of a polyamine of from greater than zero to 1000 milligrams per gallon of wastewater.

11. The method of claim 2, further comprising mixing the wastewater stream with the biochar and polyamine in a reactor.

12. The method of claim 11, wherein the reactor is a plug flow reactor.

13. The method of claim 11, further comprising adding to the wastewater stream a metal salt, an oxidant, an additional organic carbon compound, or a combination thereof.

14. The method of claim 2, further comprising separating the reject stream into a recycled water stream and a solid by-product.

15. The method of claim 14, wherein the reject stream is separated into the recycled water stream and the solid by-product in a solids separator.

16. The method of claim 15, wherein the solids separator comprises a settling basin, mesh filter, membrane filter, cloth filter, sand filter, rotating mat filter, chemical coagulator, polymer addition, centrifugal force separator, sieve, magnetic separator, plate clarifier, basin clarifier, coalescence separator or a combination thereof.

17. The method of claim 2, wherein separating the biochar, polyamine and at least one contaminant from the wastewater stream comprises filtering the wastewater stream comprising the biochar, polyamine and at least one contaminant using a filter.

18. The method of claim 17, wherein the filter is a moving bed filter, moving bed reactive filter, continuously moving bed reactive filter, a continuously moving bed filter, a cycled backwash, fluidized bed, agitated bed, horizontal flow bed of the filter substrate or a combination thereof.

19. The method of claims 2, further comprising:
testing the wastewater stream to determine an amount of the at least one contaminant present in the wastewater stream; and
adjusting a rate of addition and/or an amount of addition of the biochar and/or polyamine commensurate with the changes in the amount of the at least one contaminant present in the wastewater stream.

20. The method of claim 2, comprising:
adding biochar and a polyamine to a wastewater stream, the wastewater stream comprising at least one contaminant;
adding an iron salt to the wastewater stream;
adding ozone to the wastewater stream;
mixing the biochar, polyamine, iron salt and ozone with the wastewater stream in a plug flow reactor;
filtering the wastewater stream in a moving bed reactive sand filter to produce a treated water stream and a reject stream comprising solids;
removing the solids from the reject stream to produce a recycled water stream and a solid product.

21. The method of claim 2, comprising:
pyrolyzing a biomass to produce biochar and heat, steam and syngas;
generating electrical energy from the heat, steam and syngas;
at least partially powering a wastewater treatment system from the electrical energy, the wastewater treatment system comprising
a fluid flow pathway, comprising a wastewater inlet for introducing a wastewater stream to the pathway, a biochar/polyamine inlet, a metal salt inlet, an ozone inlet and a reactor;
a filter downstream of the reactor and biochar/polyamine inlet, the filter fluidly coupled to the fluid flow pathway;
a treated water outlet fluidly coupled to the filter;
a reject stream outlet fluidly coupled to the filter; and
a solids separator fluidly coupled to the reject stream outlet;
introducing a wastewater stream comprising at least one contaminant to the wastewater treatment system;
mixing the biochar with a polyamine to form a biochar/polyamine mixture;
adding the biochar/polyamine mixture to the wastewater stream;
adding an iron salt to the wastewater stream;
adding ozone to the wastewater stream;
mixing the biochar/polyamine mixture, iron salt and ozone with the wastewater stream in a plug flow reactor;
filtering the wastewater stream in a moving bed reactive sand filter to produce a treated water stream and a reject stream comprising solids;
removing the solids from the reject stream to produce a recycled water stream and a solid product; and
formulating the solid product into a form suitable for application to agricultural, silvicultural, residential, commercial, or municipal land or horticultural soil containers.
